(19) United States
(12) Patent Application Publication
(10) Pub. No.: US 2005/0132690 A1
(43) Pub. Date: Jun. 23, 2005

(54) Landscape rake

(76) Inventors: Gabriel G. Khairallah, Durham, NC (US); J. Brian Normann, Holly Springs, NC (US); Michael S. Sekulich, Raleigh, NC (US); Ernest F. Sykes JR., Sanford, NC (US)

Correspondence Address: CATERPILLAR INC.;100 N.E. ADAMS STREET, PATENT DEPT., PEORIA, IL, 616296490, US

(21) Appl. No.: 10/744,308

(22) Filed: Dec. 22, 2003

(51) Int. Cl. A01D 43/02

(52) U.S. Cl. 56/344

(57) ABSTRACT

Implements, such as landscape rakes, having chains with removably connected bars with teeth connected thereto are normally easier to service. The disclosed apparatus and method is an implement, such as a rake, that comprises a housing having a first-side portion and a second-side portion, a shaft rotatably supported by the housing, the shaft having a first end and a second end, a first member operatively connected to the shaft, and at least one bar removably connected to the first member.

### TECHNICAL FIELD

This disclosure relates generally to worktools, and, more particularly, to a landscape rake having at least one replaceable member located at a predetermined location and at least one bar removably connected to the member.

### BACKGROUND

Work machines, such as skid steer loaders, wheel loaders, tractors, or backhoe loaders, or other work machines use implements, such as landscape rakes, to dislodge or rake rocks, plant residue, and other material from the surface and deposit it into a bucket. Implements such as landscape rakes have a shaft that drives a plurality of members or chains that have connected thereto bars with teeth such that the members rotate the bars connected thereto. The teeth dislodge the material and carry it into the bucket. Because the teeth and bars are often in contact with the ground, material, or other such surfaces, they get worn down and must be periodically replaced.

One known landscape rake design is disclosed in U.S. Pat. No. 6,223,828 B1 that issued to Paulson et al. on May 1, 2001. It discloses a landscape rake that includes a rotatably operable rake mechanism for performing a raking function, a bucket for receiving material raked, and a fluid actuator connected to the rake mechanism for moving the rake mechanism relative to the bucket. This landscape rake design can, however, be difficult to service because the rake mechanism has teeth that are not removably connected with the chains. In addition, there are three chains that are required to drive the landscape rake. This can cause additional servicing issues because of the additional components required.

The present disclosure is directed to overcoming one or more of the problems as set forth above.

### SUMMARY OF THE INVENTION

The present embodiment is a rake, that comprises a housing having a first-side portion and a second-side portion, a shaft rotatably supported by the housing, the shaft having a first end and a second end, a first member operatively connected to the shaft, and at least one bar removably connected to the first member.

In another embodiment, a method of servicing a rake, the rake comprises a housing, a shaft rotatably supported by the housing, the shaft having a first end and a second end, a first member operatively connected to the shaft, a second member operatively connected to the shaft, and at least one bar removably connected to the first member and the second member, comprises unfastening the bar from the first member and the second member, removing the bar from the housing, inserting at least one replacement bar into the housing, and removably fastening the replacement bar to the first member and the second member.

### BRIEF DESCRIPTION OF THE DRAWINGS

For a better understanding of the present invention, reference may be made to the accompanying drawings in which:

FIG. 1 is a diagrammatic front view of a landscape rake operatively mounted to a work machine;

FIG. 2 is a diagrammatic underside view of the landscape rake; and

FIG. 3 is an exploded diagrammatic view of a portion of an underside portion of the landscape rake.

### DETAILED DESCRIPTION

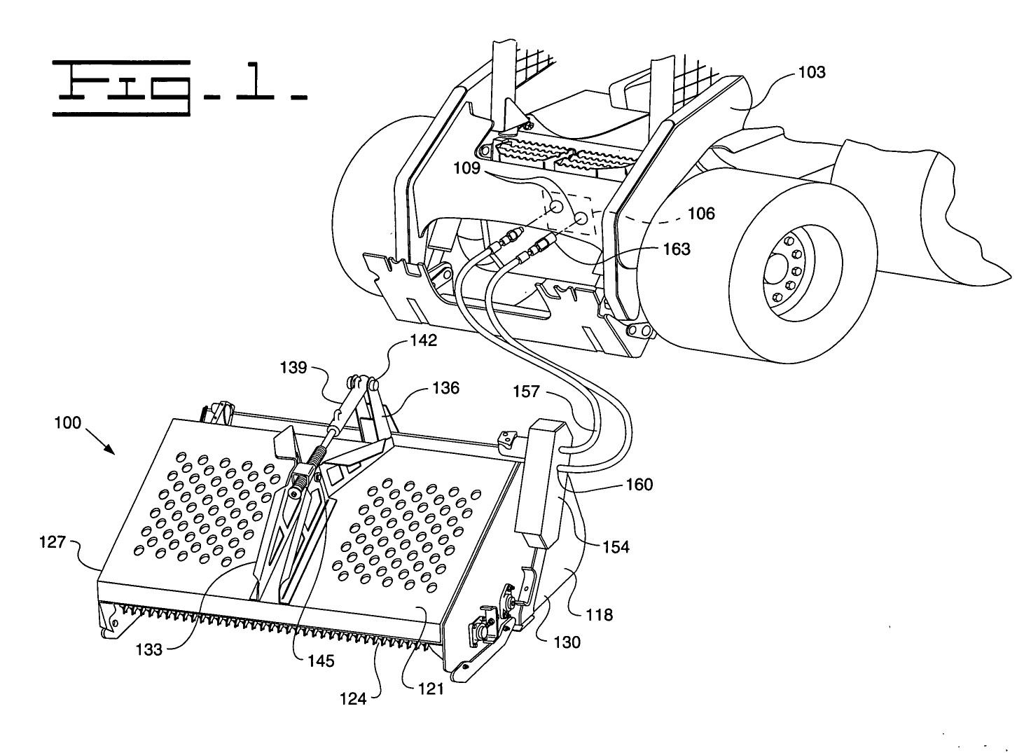

Referring to the drawings, shown in FIG. 1 is an implement, such as a rake, or more particularly, a landscape rake 100, operatively mounted in the conventional manner to a work machine 103, such as, but not limited to, a skid steer loader (depicted in FIG. 1), tractor, wheel loader, or backhoe loader. The work machine 103 includes a hydraulic system 106 including a source of pressurized fluid. The hydraulic system 106 includes a pair of hydraulic fittings 109 adapted to connect, in fluid communication, the landscape rake 100 with the hydraulic system 106 of the work machine 103.

The landscape rake 100 is pivotally connected at a pivot joint (not shown) to a bucket 118. The landscape rake 100 includes a housing 121. The housing 121 having an underside portion 124, a first-side portion 127, and a second-side portion 130. The housing 121 further includes a bracket 133 located in spaced relation to a distal end of a lift arm 136 fixedly mounted to the bucket 118. An actuator, such as a hydraulic cylinder 139, is pivotally connected to the bracket 133 and lift arm 136 by pivot joints 142, 145, respectively. The hydraulic cylinder 139 can extend to pivot the landscape rake 100 about the pivot joint 142 to a position proximal a front opening (not shown) of the bucket 118 for depositing material therein when the landscape rake 100 is operating. Conversely, the hydraulic cylinder 139 retracts to pivot the landscape rake 100 through a range of open positions spaced from the front opening to allow dumping of the contents of the bucket 118. Finally, an actuator such as a hydraulic motor 154, or more specifically a gerotor type motor is connected to the second side portion 130 of the housing 121 and is in fluid communication with the hydraulic system 106 of the work machine 103. A pair of hydraulic hoses 157 has a first-end portion 160 connected with the motor 154 and has a second-end portion 163 connectable with the hydraulic fittings 109 of the hydraulic system 106. When the hydraulic hoses 157 are connected with the motor 154 and the hydraulic fittings 109, the motor 154 is in fluid communication with the hydraulic system 106 of the work machine 103.

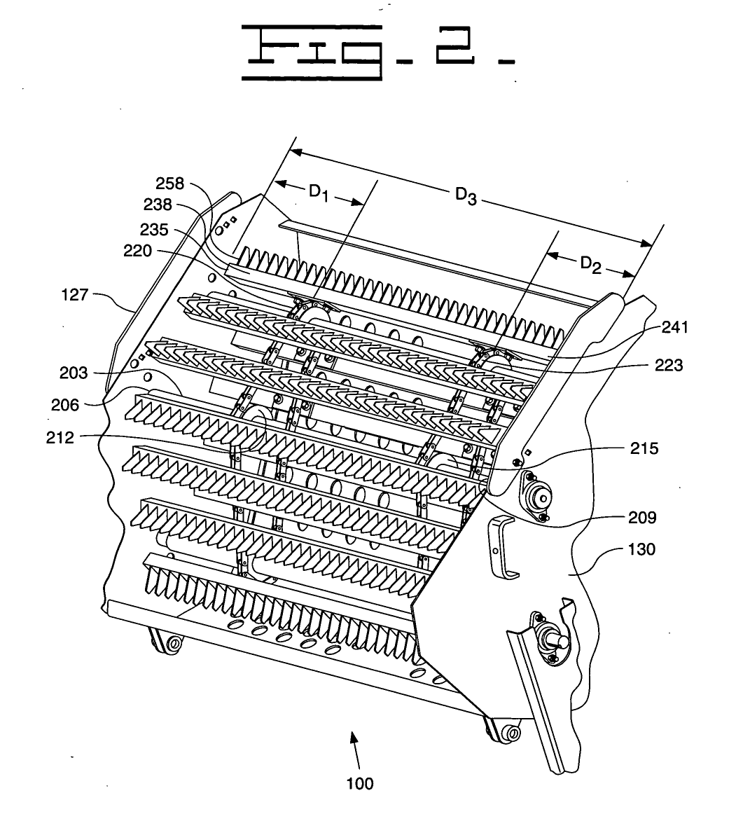

Depicted in FIG. 2, with reference numbers of previous figures being used to identify similar components therein, a shaft 203, having a first end 206 and a second end 209, has its first end 206 rotatably supported by the first-side portion 127 of the housing 121. Further, the second end 209 of the shaft 203 is rotatably supported by the second-side portion 130 of the housing 121 and is operably connected with the motor 154 so that as the motor 154 operates, it will rotate the shaft 203 in either a counter-clockwise direction or a clockwise direction depending upon the direction of flow of the pressurized fluid to the motor 154 as selected by the operator.

The shaft 203 includes a first sprocket 212 and a second sprocket 215 connected thereto by welding or another suitable process. The first sprocket 212 is located a first predetermined distance D₁ from the first end 206 of the shaft 203 and the second sprocket 215 is located a second predetermined distance D₂ from the second end 209 of the shaft 203. The first and second predetermined distances D₁, D₂ are of substantially equal lengths. In the present embodiment, the first and second predetermined distances D₁, D₂ are one third of the entire length of the shaft 203, e.g., if the overall width D₃ of the shaft 203 is about 62 inches, the first and second predetermined distances D₁, D₂ are about 20.667 inches from the first and second ends 206, 209 of the shaft 203, respectively.

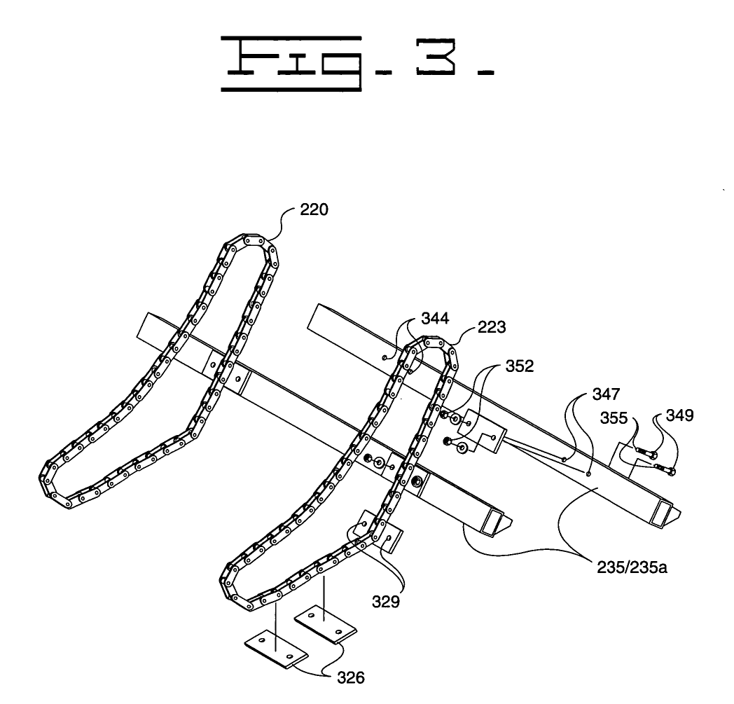

Further depicted in FIG. 2 is a first member, such as a belt, cable, linkages, etc., or as shown, a first chain 220 and a second member, such as a belt, cable, linkages, etc., or as shown a second chain 223 encircling and operatively connected to the first sprocket 212 and the second sprocket 215, respectively. When the shaft 203 rotates the first sprocket 212 and second sprocket 215 rotate further rotating the first chain 220 and the second chain 223, respectively. The first and second chains 220, 223 are located the first and second predetermined distances D₁, D₂ from the first end 206 and the second end 209 of the shaft 203, respectively, as described above. As depicted in FIG. 3, the first chain 220 and second chain 223 each include a plurality of tabs 326 connected thereto by welding or another suitable process. Each tab 326 includes at least one aperture 329. For exemplary purposes herein, two apertures 329 are depicted in FIG. 3. It should be understood, however, that any numbers of apertures can be used without deviating from the intent of the present embodiment.

As depicted in FIG. 2, a plurality of bars 235, each having first ends 238 and second ends 241, are removably connected to the first chain 220 and the second chain 223. The bars 235 are at least partially enclosed within the housing 121. The bars 235 further include a plurality of teeth 258 connected thereto by welding or another suitable process. As depicted in FIG. 3, with reference numbers of previous figures being used to identify similar components therein, each bar 235 includes a plurality of apertures, for exemplary purposes herein, the present embodiment includes a first pair of apertures 344 therethrough and a second pair of apertures 347 therethrough. The bars 235 are removably connected to the first and second chains 220, 223 by using a plurality of mechanical fasteners such as bolts 349 and nuts 352. The bolts 349 have an end portion 355 and are longer than the height of the bars 235 such that the end portion 355 of the bolt 349 protrudes out of the first pair and second pair of apertures 344, 347 when inserted therein. To removably connect the bars 235 to the first and second chains 220, 223, the bolts 349 are inserted through the apertures 329 of the tabs 326 of the first and second chains 220, 223 and then through the first and second pair of apertures 344, 347 of the bars 235. The nuts 352 are then fastened to the end portion 355 of the bolts 349 removably connecting the first and second chains 220, 223 to the bar 235. This is repeated for each bar 235 so that each bar 235 is removably connected to the first and second chains 220, 223.

### Industrial Applicability

In operation, with the landscape rake 100 positioned proximal to the front opening of the bucket 118, pressurized fluid will be supplied to the motor 154 to operate the motor 154 and rotate the shaft 203. The bucket 118 is articulated to bring the teeth 258 into contact with a surface such as the ground surface, and the work machine 103 will be moved in either a forward or reverse direction such that the teeth 258 will dislodge or rake rocks, plant residue, and other desired material from the surface and deposit it into bucket 118 through the front opening. After frequent use of the landscape rake 100, the teeth 258 and/or the bars 235, wear out and need to be replaced.

To service the landscape rake 100 the bars 235 are unfastened from the first and second chains 220, 223 by unscrewing the nuts 352 from the end portion 355 of the respective bolts 349, removing them from the first and second pair of apertures 344, 347 of the bar 235 to be removed and from the apertures 329 of the tabs 326 of the first and second chains 220, 223. The bar 235 is then removed from the housing 121. A replacement bar 235a, such as a new bar with new teeth, the same bar with new teeth, or a new bar with the same teeth, is then inserted into the housing 121 and re-fastened to the first and second chains 220, 223 by inserting the bolts 349 through the apertures 329 of the tabs 326 of the first and second chains 220, 223 and then through the first and second pair of apertures 344, 347 of the bars 235. The nuts 352 are then fastened to the end portions 355 of the respective bolts 349 removably connecting the first and second chains 220, 223 to the bar 235. This is repeated until all of the worn out bars and teeth are replaced.

In operating the landscape rake 100 of the present embodiment, the location of the first and second chains 220, 223 at the first and second predetermined distances D₁, D₂ increases the efficiency of the landscape rake 100 and increases the efficiency by which the debris enters the bucket 118 during operation thereof. These efficiencies are created because the load profile on the shaft 203 and the load profile on the bars 235 are reduced because there is no longer a center force acting on the bars 235 or the shaft 203 and the two external forces are moved closer to the center of the shaft 203. The reduction of the load profiles and the efficiencies created permits there only to be two chains used instead of other arrangements that may use three or more chains to drive the landscape rake 100.

Other aspects, objects and advantages of the invention could be obtained from a study of the drawings, the disclosure and the appended claims.

1. A rake, comprising:
a housing having a first-side portion and a second-side portion;
a shaft rotatably supported by the housing, the shaft having a first end and a second end;
a first member operatively connected to the shaft; and
at least one bar removably connected to the first member.

2. The rake of claim 1, further comprising a second member connected to the shaft, the bar being removably connected to the second member.

3. The rake of claim 2, wherein the first member comprises a first chain and the second member comprises a second chain.

4. The rake of claim 3, wherein the first chain is operatively connected to the shaft at a first predetermined distance from the first end of the shaft and the second chain is connected to the shaft at a second predetermined distance from the second end of the shaft, the first predetermined distance and the second predetermined distance are substantially equal to one-third of a width of the shaft.

5. The rake of claim 1, wherein the first member has at least one tab connected thereto, the bar being removably connected to the tab of the first member.

6. The rake of claim 1, further comprising at least one tooth connected to the bar.

7. An implement, comprising:
a housing having a first-side portion and a second-side portion;
a shaft rotatably supported by the housing, the shaft having a first end and a second end;
a first chain operatively connected to the shaft;
a second chain operatively connected to the shaft; and
at least one bar removably connected to the first and second chain.

8. The implement of claim 7, wherein the implement is a rake.

9. The implement of claim 7, wherein the first chain has at least one tab connected thereto and the second chain has at least one tab connected thereto, the bar being removably connected to the tab of the first chain and the tab of the second chain.

10. The implement of claim 7, further comprising at least one tooth connected to the bar.

11. The implement of claim 7, wherein the first chain is operatively connected to the shaft at a first predetermined distance from the first end of the shaft and the second chain is operatively connected to the shaft at a second predetermined distance from the second end of the shaft, the first predetermined distance and the second predetermined distance are substantially equal to one-third of a width of the shaft.

12. A method of servicing a rake, the rake comprising a housing, a shaft rotatably supported by the housing, the shaft having a first end and a second end, a first member operatively connected to the shaft, a second member operatively connected to the shaft, and at least one bar removably connected to the first member and the second member, comprising:
unfastening the bar from the first member and the second member;
removing the bar from the housing;
inserting at least one replacement bar into the housing; and
removably fastening the replacement bar to the first member and the second member.

13. The method of claim 12, wherein the first member comprises a first chain and the second member comprises a second chain.

14. The method of claim 13, wherein the first chain has at least one tab connected thereto and the second chain has at least one tab connected thereto, the bar being removably connected to the tab of the first chain and the tab of the second chain.

15. The method of claim 14, further comprising:
unfastening the bar from the tab of the first chain and the tab of the second chain; and
removably fastening the replacement bar to the tab of the first chain and the tab of the second chain.

16. The method of claim 13, wherein the first chain is located a first predetermined distance from the first end of the shaft and the second chain is located a second predetermined distance from the second end of the shaft.

17. The method of claim 16, wherein the first predetermined distance and the second predetermined distance are substantially equal.

18. The implement of claim 16, wherein the first predetermined distance and the second predetermined distance are substantially equal to one-third of a width of the shaft.
